(19) United States
(12) Patent Application Publication
(10) Pub. No.: US 2025/0222630 A1
(43) Pub. Date: Jul. 10, 2025

(54) ACTIVE SELF-RELEASING MOLDS FOR CASTING OF COMPLEX PARTS

(71) Applicant: Lawrence Livermore National Security, LLC, Livermore, CA (US)

(72) Inventors: Henry Paul Martinez, Livermore, CA (US); Kyle T. Sullivan, Livermore, CA (US); Julie Anne Mancini, Livermore, CA (US); Elaine Lee, Moraga, CA (US); Caitlyn Christian Krikorian, Livermore, CA (US)

(21) Appl. No.: 18/404,497

(22) Filed: Jan. 4, 2024

(51) Int. Cl. B29C 39/26; B29C 33/38; B29C 33/40; B29C 33/50; B29C 39/02; B33Y 80/00

(52) U.S. Cl. CPC B29C 39/26; B29C 33/405; B29C 33/50; B29C 39/02; B33Y 80/00; B29C 33/3842; B29K 2821/00

(57) ABSTRACT

A product includes a three-dimensional structure including a shape changing material, where the three-dimensional structure has a predefined cavity configured to function as a mold for a castable material. The three-dimensional structure is characterized as exhibiting a shape change in response to a stimulus, where the shape change is reversible. The three-dimensional structure is configured to release the castable material in response to the stimulus.

This invention was made with Government support under Contract No. DE-AC52-07NA27344 awarded by the United States Department of Energy. The Government has certain rights in the invention.

### FIELD OF THE INVENTION

The present invention relates casting processes, and more particularly, this invention relates to active self-releasing molds for casting of complex parts.

### BACKGROUND

Conventional molds for forming complex shapes of casted material include molds such as a hollowed-out block that is filled with casting material, typically in two pieces, that release the casted material; articulated molds having multiple pieces that come together to form a complete mold and disassemble to release the finished casting; piece-molding that use several different molds, each creating a section of a complex complicated object; soft molds that are peeled away from the casted material; dissolvable molds that dissolve, melt, etc. away to release the casted material; etc. Drawbacks of conventional molding processes include irregularities in the casted material caused by seams and imperfections of the molds as well as the access ports for pouring the material into the molds. Moreover, conventional mold casting processes use specialized machinery and mold material that limit the type of casting material.

The majority of polymer molds are silicone or Teflon™ because these materials allow the cast material to be demolded quickly. Demolding typically is defined as peeling away the silicone mold. Moreover, molds formed with acrylate polymer material tends to poison the silicone catalyst of the casting material such that the cast material is not fully cured and cannot be removed efficiently from the molds. Surface treatments of the mold surfaces is essential for removing the cast material from the mold.

Prototyping 3D printed molds is promising for casting intricate, fine features; however, the cast material sticks to the molds making it difficult to mold specific features. The gold standard for forming high fidelity, precision molds remain with machined molds in metal; however, the mold has to be coated with a release agent, such as PTFE, so the cast material can be removed from the mold.

There remains a need for an economical efficient method for forming a mold that is capable of fabricating cast shapes with complex features.

### SUMMARY

According to one embodiment, a product includes a three-dimensional structure including a shape changing material, where the three-dimensional structure has a predefined cavity configured to function as a mold for a castable material. The three-dimensional structure is characterized as exhibiting a shape change in response to a stimulus, where the shape change is reversible. The three-dimensional structure is configured to release the castable material in response to the stimulus.

According to another embodiment, a method for casting a part using a self-releasing mold includes obtaining a mold having a cavity, the mold comprising a shape changing material, where the cavity of the mold has a first shape. Further, the method includes exposing the mold to a stimulus, wherein the cavity of the mold changes to a second shape in response to the stimulus, infilling a curable material into the cavity, curing the curable material, and reducing the stimulus. The cavity of the mold changes to the first shape in the reduced stimulus thereby causing the mold to be separated from the cured material.

According to yet another embodiment, a method for casting a part using a self-releasing mold includes obtaining a mold having a cavity, the mold comprising a shape changing material, where the cavity of the mold has a first shape. Further, the method includes infilling a curable material into the cavity, curing the curable material, and exposing the mold to a stimulus. The cavity of the mold changes to a second shape in response to the stimulus thereby causing the mold to be separated from the cured material.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a schematic drawing of a self-releasing mold, according to one embodiment.

FIG. 2 is a flow chart of a method using a self-releasing mold, according to one embodiment.

FIG. 3 is a schematic drawing of a method of casting a part in an active self-releasing mold, according to one embodiment.

FIG. 4 is a schematic drawing of a method of casting a part with tunable dimensions using a tunable shape-changing mold, according to one embodiment.

FIG. 5 is a flow chart of a method using a self-releasing mold, according to another embodiment.

FIG. 6A is a schematic drawing of one example of liquid crystal (LC) oligomer synthesis, according to one embodiment.

FIG. 6B is a series of schematic drawings of a magnified view of alignment of liquid crystal elastomer (LCE) material, according to various embodiments. Part (a) is a schematic drawing of an LC oligomer, part (b) is a schematic drawing of uncured, polydomain LC oligomers in a resin, part (c) is a schematic drawing of uncured, aligned nematic monodomain LC oligomers in a resin, and part (d) is a schematic drawing of a portion of cured, nematic monodomain LCEs.

FIG. 6C is a schematic drawing of the range of orientations of liquid crystal molecules, according to one embodiment.

FIG. 7 is a schematic drawing of an actuation of a part in response to a stimulus.

FIG. 8 is a set of images of an LCE self-releasing mold, according to one embodiment. Part (a) is a part cast in an LCE self-releasing mold, and part (b) is the release of the part from the LCE mold.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

It is also noted that, as used in the specification and the appended claims, wt. % is defined as the percentage of weight of a particular component relative to the total weight/mass of the mixture. Vol. % is defined as the percentage of volume of a particular compound relative to the total volume of the mixture or compound. Mol. % is defined as the percentage of moles of a particular component relative to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

In addition, the present disclosure includes several descriptions of a “resin” used in an additive manufacturing process to form the inventive aspects described herein. It should be understood that “resins” (and singular forms thereof) may be used interchangeably and refer to a composition of matter comprising a plurality of oligomers, particles, small molecules, etc. coated with and dispersed throughout a liquid phase. In some inventive approaches, the resin may be optically transparent having a greater than 90% transmittance of light. In some inventive approaches, the resin is light sensitive where exposure to a particular light source changes the physical and/or chemical properties of the resin.

The following description discloses several preferred structures formed via photo polymerization processes, e.g., projection micro stereolithography, photolithography, two photon polymerization, etc., or other equivalent techniques and therefore exhibit unique structural and compositional characteristics conveyed via the precise control allowed by such techniques. The physical characteristics of a structure formed by photo polymerization processes may include fabrication of a solid micro-structure having complex geometric arrangement of ligaments, filaments, etc. The formation of a three-dimensional structure includes exposing a resin to light, where a pattern in the photoresist is created by the exposing light.

The following description discloses several preferred embodiments active self-releasing molds for casting of complex parts, and/or related systems and methods.

In one general embodiment, a product includes a three-dimensional structure including a shape changing material, where the three-dimensional structure has a predefined cavity configured to function as a mold for a castable material. The three-dimensional structure is characterized as exhibiting a shape change in response to a stimulus, where the shape change is reversible. The three-dimensional structure is configured to release the castable material in response to the stimulus.

In another general embodiment, a method for casting a part using a self-releasing mold includes obtaining a mold having a cavity, the mold comprising a shape changing material, where the cavity of the mold has a first shape. Further, the method includes exposing the mold to a stimulus, wherein the cavity of the mold changes to a second shape in response to the stimulus, infilling a curable material into the cavity, curing the curable material, and reducing the stimulus. The cavity of the mold changes to the first shape in the reduced stimulus thereby causing the mold to be separated from the cured material.

In yet another general embodiment, a method for casting a part using a self-releasing mold includes obtaining a mold having a cavity, the mold comprising a shape changing material, where the cavity of the mold has a first shape. Further, the method includes infilling a curable material into the cavity, curing the curable material, and exposing the mold to a stimulus. The cavity of the mold changes to a second shape in response to the stimulus thereby causing the mold to be separated from the cured material.

A list of acronyms used in the description is provided below.
3D three-dimensional
AM Additive manufacturing
DIW direct ink writing
LC Liquid crystal
LCE Liquid crystal elastomer
nm nanometer
PμSL projection micro stereolithography
SLA stereolithography
SMP shape memory polymer
μm micron
UV ultraviolet
wt. % weight percent

According to one embodiment, a mold is formed with a shape changing material. A shape changing material is a material that changes shape in response to an applied stimulus, and upon removal of the stimulus, the material returns to its original shape. As described herein, a mold may be formed with a shape changing material that responds to stimuli by changing shape of the structure comprised of the shape changing material that responds to stimuli in a predefined manner and functions as an active self-releasing molds for casting of complex parts.

In some approaches, the shape changing material holds a shape in the presence of a stimulus where the shape in the presence of the stimulus is different than the original shape of the material. A structure, part, etc. may be formed with a shape changing material, and the structure changes shape in response to a stimulus. The material is a stimulus-responsive material. The structure maintains the stimulus-induced shape while the stimulus is applied to the shape changing material. The shape remains stable during the entire duration of the stimulus and then reverts back the original printed dimensions following removal of the stimuli. For example, during heating a LCE cylinder mold in the oven, the LCE cylinder mold remains in a contracted diameter state (i.e., the stimulus-induced shape) the entire time during heating in the oven. Once the LCE cylinder mold is removed from the oven, the LCE cylinder mold increases in diameter to the original printed dimensions. The structure may retain the stimulus-induced shape, where the shape of the structure remains as at least 90% of the initial stimulus-induced shape for the duration of the exposure to the stimulus. In some approaches, the structure may retain at least 98% of the stimulus-induced shape for the duration of the exposure to the stimulus. The duration of the exposure of the stimulus may include minutes, hours, day, weeks, etc.

Upon removal of the stimulus, the structure made of the shape changing material returns to the original shape of the structure. In one approach, the shape changing material has a specific, original shape, and when a stimulus (e.g., a specific set of conditions determined according to the composition of the shape changing material) is exposed to the material, the material changes shape, deforms, etc., and then removal of the stimulus causes the material to revert back to its original shape. For example, a mold comprising a shape changing material may be used to cast a curable material, and after curing the cast material, the mold/cast is exposed to a stimulus, and the mold deforms to release the cast material.

In various approaches, a structure comprised of shape changing material may be induced to intermediate shape changes with different stimuli. In one approach, the intermediate shape changes may include intermediate dimensions. Moreover, the extent of shape change may be tuned according to the shape change material and the stimuli that induces the shape change.

Various approaches may use any type of shape changing material known in the art that is compatible with the intended purpose, as would become apparent to one skilled in the art after reading the present disclosure. In one approach, a shape changing material includes shape memory polymers (SMPs). In another approach, a shape changing material includes elastomer composites (e.g., elastomers filled with magnetic filler). In yet another approach, a shape changing material includes polymers with crystallographic programmed alignment (e.g., liquid crystal elastomers, block copolymers, etc.).

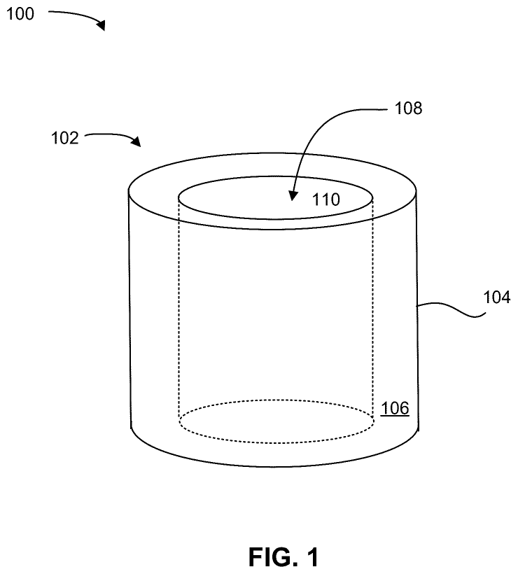

FIG. 1 depicts a product 100 that includes a self-releasing mold, in accordance with one embodiment. As an option, the present product 100 may be implemented in conjunction with features from any other embodiment listed herein, such as those described with reference to the other FIGS. Of course, however, such a product 100 and others presented herein may be used in various applications and/or in permutations which may or may not be specifically described in the illustrative embodiments listed herein. Further, the product 100 presented herein may be used in any desired environment.

According to one embodiment, as illustrated in FIG. 1, a product 100 includes a self-releasing mold 102. The mold 102 is a three-dimensional structure 104 comprised of shape changing material 106. As described herein, the shape changing material holds a shape in the presence of a stimulus where the shape in the presence of the stimulus is different than the original shape of the material. In the absence of the stimulus, the material returns to the original shape of the material. In one approach, the shape changing material is a shape memory polymer material. In another approach, the shape changing material is a hydrogel. In yet another approach, the shape changing material is a LCE mesogen material.

According to one embodiment, a formulation of a resin including shape changing material components for printing the mold structure comprised of a material that changes shape based on an external stimulus. In one approach, a formulation of the resin may include an elastomer ink. In one approach, the formulation of the ink includes a shape changing material such as liquid crystal elastomer (LCE) mesogen material. In yet another approach, a formulation of the resin may include shape changing polymers, such as polyurethanes, thiolenes, etc. Shape changing polymers are stimulated by heat. In yet another approach, a formulation of the resin may include a hydrogel. These formulations are by way of example only and are not meant to be limiting in any way.

The three-dimensional structure 104 has a predefined cavity 108 configured to function as a mold for a castable material. In preferred approaches, the castable material does not adhere to the surface of the cavity of the mold. In some approaches, the shape changing material includes an additive configured to inhibit adherence of the castable material to a surface of the cavity. The mixture (ink/resin) for forming the mold may include an additive for inhibiting the adherence of the cast material to the mold material. In one approach, an additive may be included in the formulation of the resin in order to inhibit adherence of the casting material to the mold material. In one example of using shape changing polymers, the polymers may include fluorinated acrylates that have shape change behavior.

In other approaches, additives to the ink to avoid adherence of the cast material to the formed mold may be tuned to the curing process of the cast material, the material being cast. For example, a hydrophobic cast material would preferably be formed in a hydrophilic mold, and conversely, a hydrophilic casted material would preferably be formed in a hydrophobic mold. Addition of fluorinated constituents into the ink mixture, so that the fluorinated bonds hang off the backbone and will assist in preventing the cast material from sticking to the surface of the mold. The fluorinated constituents may be added as a filler in the mold material.

In some approaches, polymer molds may include inorganic materials with shape changing for self-releasing molds. Polymer composites, magnetic field induced shape change would include magnetic filings in a polymer matrix, and then solid polymer as well. The mole material may also include ceramic material as an additive (similar to a filler of magnetic filings) the same effect, piezoelectric filler in a polymer may be affected by electric stimuli.

In other approaches, the formulation of the mold may include metals, e.g., expand to shape changing alloys as molds, shape changing ceramics, polymer materials, high temperature curing materials, etc. Shape changing alloys (e.g., NiTi,) may be fabricated using different printing methods than DIW and PμSL, instead using lasers and powder based system. Other approaches for shape changing ceramics may include ALD coating on a polymer substrate so it is really thin, even piezoelectric ceramics may be used for a mold. Ceramics and metals will have a smaller shape change, but the shape change may be sufficient for a self-releasing mold, especially for rigid, high temperature materials. In some approaches, the shape changing material includes an additive that that is configured to cause a shape change of the 3D structure in response to a stimulus. For example, the additive may include magnetic filings, a piezoelectric ceramic material, a metal, etc.

The predefined cavity 108 of the 3D structure 104 has a surface 110 that has predefined pattern of complex features. In one approach, the predefined cavity has a surface for defining at least a portion of an outer surface of the cured material in a predefined shape corresponding to the features. In a preferred approach, the predefined pattern of features is for forming a predefined cast of a structure. For example, the surface of the predefined cavity is a negative of a predefined part for the castable material, where the castable material infilled in the cavity forms a positive of the predefined part.

The 3D structure may be fabricated using a shape changing material resin/ink and additive manufacturing (AM) techniques. Various AM techniques allow fabrication of printed mold complexity. The mold may be printed using a resin comprising a shape changing material where the mold has a cavity having an intricate geometric design. The mold may be printed using additive manufacturing techniques, such as direct ink writing, projection micro stereolithography, etc. The structure and pattern of features of the mold may be predefined and printed using additive manufacturing techniques. The surface of the cavity of the mold may include intricate features that typically are difficult to cast using conventional mold/cast methods.

According to one embodiment, with recent ink and manufacturing advancements, complex 3D printed molds may be formed according to a programmed shape. Using these stimuli responsive inks and manufacturing advancements, a stimuli-responsive mold can shape a cast material, and the 3D printed mold may self-release once the material is cured. This type of self-release molding may reduce manufacturing time and reduce handling of optics and manufacturing with low dexterity robotic interactions).

The 3D structure 104 is characterized as exhibiting a shape change in response to a stimulus. The shape change may be reversible. For example, in the absence of the stimulus, the shape of the 3D structure returns to the original shape of the 3D structure. The 3D structure 104 is configured to release cured cast material in response to a stimulus.

In one approach, the 3D structure of the mold may be engineered and fabricated to have the desired features of the cast product when the mold has a shape induced by an external stimuli (induced shape change). In another approach, the 3D structure of the mold may be engineered and fabricated to have the desired features of the cast product when the mold is in its original shape at ambient conditions. Thus, a shape change of the mold by external stimuli could release the mold from the cast material.

Responsive materials have been tailored into inks and resins for 3D printing such as in stereolithography (SLA), volumetric additive manufacturing, two photon lithography, and direct ink write (DIW) and can be tuned to shape change in response to targeted stimuli. One example of a responsive material are liquid crystal elastomers (LCEs), that combine the properties of liquid crystals (orientational order and mobility) and polymer networks (rubbery elasticity). Due to the coupling of the anisotropic liquid crystal (LC) molecules to elastomer networks, LCEs exhibit a reversible shape changing effect upon an anisotropic-to-isotropic transition, which can be triggered by external stimuli, such as temperature, light or solvent. The resultant shape change is dictated by the alignment direction of the liquid crystals, which is programmed during printing (unidirectionally via shear in DIW and 360° via photo or magnetic alignment SLA methods).

In one example of a hydrogel mixture, in the presence of water, the structure comprising water-soluble material swells to release the casted material, and then removal of the water (e.g., dehydration, evaporation, etc.) the mold material returns to the original shape.

For example, liquid crystal elastomers (LCEs) have mesogens within the LCE backbone that can be unidirectionally aligned with the direct ink writing (DIW) extrusion shearing force, thereby programming a repeatable shape change in a formed structure when the structure is stimulated. LCEs may also be aligned through light and a magnetic field in a stereolithography (SLA) platform to increase shape change. Methodologies for forming these shape changing LCE structures are disclosed in U.S. Pat. Nos. 11,794,406 and 11,745,420, which are herein incorporated by reference.

For instance, in one example, there has been a significant uptick of reports of direct ink write (DIW) printing of LCEs. LCEs combine the properties of liquid crystals (orientational order and mobility) and polymer networks (rubbery elasticity). Mesogens within the LCE backbone can be unidirectionally aligned with the DIW extrusion shearing force, programming the repeatable shape change when stimulated. Mesogens can also be aligned through light or a magnetic field in a stereolithography (SLA) platform to increase shape change and printed mold complexity. The alignment of the liquid crystals in the LCE is randomized when heated above their nematic-to-isotropic transition temperature, and then during extrusion, the LC molecules are aligned along the printing direction. As the strand is printed, it cools to room temperature and is cured with ultraviolet (UV) light, thereby fixing the orientation of the LC molecule alignment. When heated, the shape change of the printed strand is limited to contraction along the filament axis and expansion perpendicular to the filament axis. Due to the coupling of the anisotropic liquid crystal (LC) molecules to elastomer networks, LCEs exhibit a reversible shape changing effect upon an anisotropic-to-isotropic transition, which can be triggered by external stimuli, such as temperature, light, electric field, etc. This shape changing property of LCE material may be used as a self-releasing mold. Moreover, the shape change characteristic of the LCE material may be repeated multiple times thereby allowing an LCE mold to be reused.

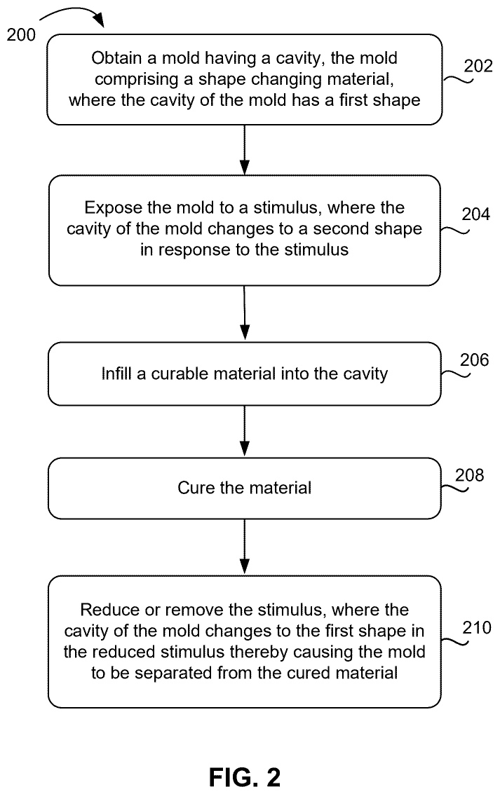

FIG. 2 shows a method 200 for casting a part using a self-releasing mold, in accordance with one aspect of one inventive concept. As an option, the present method 200 may be implemented to construct structures such as those shown in the other FIGS. described herein. Of course, however, this method 200 and others presented herein may be used to form structures for a wide variety of devices and/or purposes which may or may not be related to the illustrative embodiments listed herein. Further, the methods presented herein may be carried out in any desired environment. Moreover, more, or less operations than those shown in FIG. 2 may be included in method 200, according to various embodiments. It should also be noted that any of the aforementioned features may be used in any of the embodiments described in accordance with the various methods.

The method 200 may begin with operation 202 of obtaining a mold having a cavity. The mold includes a stimuli responsive material as described herein. The mold has an original shape under ambient conditions (e.g., room temperature, no applied pressure, etc.). The cavity of the mold has an original predefined shape. In some approaches, the cavity of the mold has a surface comprising predefined features in a negative form such that the cast material reflects a positive form of the mold pattern. In some approaches of method 200, the features of the mold are predefined to be a negative of the cast in the stimulus-induced shape. For example, the features to be cast are defined according to the shape of the mold in the stimulus-induced shape (e.g., increased height and reduced diameter of the mold). As described herein, the mold may be formed using AM techniques such as DIW, lithography-based AM system (e.g., PμSL), etc.

In one approach, the shape changing material includes a LCE mesogen material. In another approach, the shape changing material includes a shape changing polymer material. In yet another approach, the shape changing material includes a hydrogel. These approaches are by way of example only, and not meant to be limiting in any way. The shape changing material may be a material that is engineered to change shape in response to exposure to a stimulus.

In some approaches, the shape changing material may include an additive configured to cause a shape change of the mold in response to the stimulus as described herein. The additive may include a magnetic filing, a piezoelectric ceramic material, a metal, etc. For example, a shape changing material that includes an additive such as magnetic filings will be susceptible to a shape change in response to a stimulus being application of a magnetic field.

Operation 204 includes exposing the mold to a stimulus, where the mold changes to a different shape in response to the stimulus. The cavity of the mold changes to a different shape in response to the stimulus that is determined according to the composition of the shape changing material. The shape of the cavity of the mold in the presence of a stimulus is different than the shape of the cavity of the mold in the absence of a stimulus. Stimuli to trigger the shape change of the material of the mold include water solvent, light, moisture, magnetic field, electrical conductivity, resistive heating, voltage change, vacuum, pressure, expansion, change in vacuum, etc.

In some approaches, stimuli for prompting the shape change of the shape changing material of the mold may be applied externally. Stimuli may include a temperature change, a solvent change, application of radiation (e.g., laser, UV, etc.), application of electric field (e.g., application of an electric current, voltage, etc.), application of a magnetic field, a pressure change, etc. The stimulus may be selected according to the composition of the shape changing material that comprises the mold.

Operation 206 includes infilling a curable material into the cavity of the 3D structure. The infilling of the curable material occurs during the exposure of the mold to the stimulus. During the infilling and curing of the curable material, the mold remains in the stimulus-induced shape of the mold.

The curable material includes a material that does not adhere to the surface of the cavity of the mold. In one approach, the curable material may be a siloxane monomer. In one approach, the curable material may include a monomer capable of crosslinking in response to a curing treatment. In one approach, the curable material is a monomer capable of crosslinking in response to heat treatment.

Operation 208 includes curing the curable material that is infilled in the cavity of the mold. In some approaches, the curing treatment of the curable material is the same as the stimulus for changing the shape of the mold, thus, the treatment of the mold material in the shape change may also cure the material infilled in the cavity of the expanded mold. In other approaches, the curing treatment may be different than the stimulus treatment that changes the shape of the mold. For example, the curing treatment may be an application of UV light to the curable material while the mold is being heated to the expanded shape. During the curing of the casting material, e.g., silicone elastomer, the mold material does not adhere to the casting material.

Operation 210 includes reducing the stimulus. In preferred approaches, reducing the stimulus includes removing the stimulus and stopping the exposure of the mold to the stimulus. In other approaches, the stimulus may be reduced by a sufficient amount to enable shape change of the mold for the following purpose. In the absence or sufficient reduction of the stimulus, the mold structure returns to or toward its original shape thereby causing the mold to be separated, at least in part, from the cured material, so that the cured material may be readily removed from the mold. The mold is preferably configured such that the cured material does not adhere to the surface of the cavity of the mold, especially once the stimulus is removed. In preferred approaches, the mold is comprised of a composition that does not adhere to the cured material.

The cured material may then be removed from the mold by simply lifting the cured material out of the mold because the mold in the absence of a stimulus has a different shape than the mold shape used to infill the curable material.

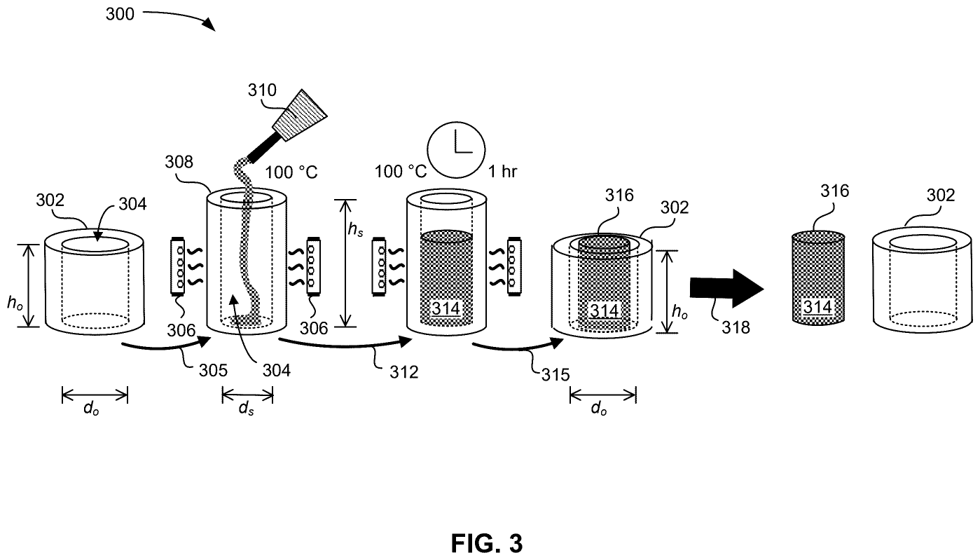

In one example, a method 300 of forming a cast material using a self-releasing mold is illustrated in FIG. 3. First, a self-releasing mold 302 is obtained, where the mold 302 is made of shape changing material, and has a cavity 304 for infilling a castable material. As an example, the height ho and diameter do represent dimensions of the mold in the absence of a stimulus.

Operation 305 includes exposing the mold 302 to a stimulus 306, whereby the mold structure actuates and changes shape to stimulus-induced shape 308. As illustrated, during application of the stimulus 306, e.g., heat as shown here, the cavity 304 of the original mold 302 changes shape to a stimulus-induced shape 308 having an expanded height hₛ and smaller diameter dₛ. The stimulus-induced shape is different than the original shape of the mold.

While the mold is being exposed to the stimulus (e.g., heat), operation 305 includes infilling a castable material 310 into the cavity 304 of the stimulus-induced shape 308 of the mold. The castable material may be infilled into the cavity using a syringe, or any method well understood in the art.

In this example, the curing treatment of operation 312 includes heating the castable material 310 to the temperature that maintains the stimulus-induced shape 308 of the mold also cures the castable material 310 to a cured cast 314 having the shape of the cavity of the mold. Operation 312 includes curing the castable material 310 by applying heat at a temperature of about 100° C. for about one hour. In this example, the temperature of the curing is the same temperature that acts as a stimulus to maintain the stimulus-induced shape 308 of the mold. The castable material may be cured by a curing treatment according to the composition of the castable material. For example, the curing treatment may include application of heat, UV, moisture, etc.

Operation 315 includes removing the stimulus. For example, the application of heat is removed from the system and the temperature of the system returns to room temperature. The mold 302 is no longer exposed to a stimulus 306, and therefore, the mold returns to its original shape. The infilled castable material 310 has become a cured cast 314 having a predefined shape 316 of the stimulus-induced shape 308 of the mold. In the absence of the stimulus 306, the mold 302 returns to its original shape where the cavity 304 has the original dimensions of height ho and diameter do.

Operation 318 includes removing the cured cast 314 having the predefined shape 316 from the mold 302. The mold 302 may self-release from the cured cast 314 (e.g., the mold is a self-releasing mold). Preferably, the mold 302 in its original shape is reusable for another casting process.

With stimuli responsive inks and manufacturing advancements, the printing of complex 3D molds may be possible using predefined programming to shape a cast material and to self-release once the material is cured.

In one approach, a structure may be set into a stimulus-induced shape. For example, a mold may undergo a stimulus-induced shape change that is set until the mold is subjected to a second stimulus, removal of stimulus, etc. that changes the shape of the mold to its original shape. A structure set into an intermediate shape change may be an adaptable mold, for example, for tunable casting dimensions. In another approach, a stimulus-induced shape change may be stopped at an intermediate state as there is an associated time constant with the shape change. In one approach, the adaptable mold may be an interlocking shape-changing mold. In another approach, the adaptable mold may be a tunable shape-changing mold.

In one approach, a shape changing material may hold a shape induced by a first stimulus until a second stimulus is applied. In various approaches, different temperatures for heating and/or two different wavelengths of light may be employed as a stimulus for changing the shape of the mold: one stimulus for inducing the mold shape change and a second different stimulus for releasing the mold from the cast material. For example, a light stimulus at one wavelength may be used to induce a mold shape change before adding the cast material, and a light stimulus at a different wavelength may be used to release the mold from the cast material.

In one example, a method of casting a part may include exposure of a self-releasing mold to multiple stimuli according to the composite of the mold. A mold may be formed with a composite comprising LCE filled with magnetically-tagged filler. Application of a magnetic field causes a shape change of the mold to a certain extent due to an increased stiffness of the LCE and the limited range of filler motion. Thus, application of heat (i.e., a second different stimuli) may further enable the mold to achieve a final, complete, etc. shape change.

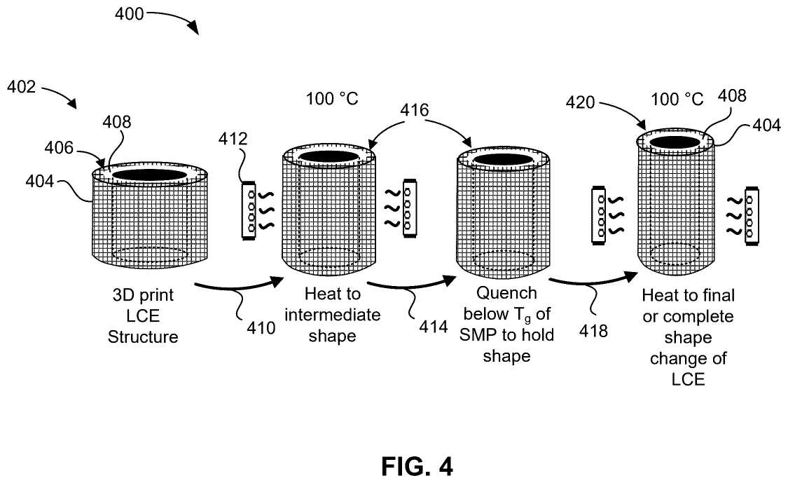

In another approach, FIG. 4 illustrates a method 400 of casting a part using a shape using a shape-changing mold, according to one embodiment. A structure 402 includes a shape memory polymer (SMP) composite 404 that is coated 406 on the outside of a 3D printed liquid crystal elastomer (LCE) cylinder 408. The 3D printed LCE cylinder 408 may be a mold, template, etc. After a heating operation 410, where heaters 412 surround and heat the structure 402, the structure 402 comprising the LCE cylinder 408/SMP composite 404 may be quenched 414 to hold an intermediate shape 416. A second heating operation 418 may be applied to heat the structure 402 to a final or complete shape change 420 of the LCE cylinder 408 and in turn the shape of the SMP composite 404. In various approaches, the multiple stimuli may include exposure to light at multiple wavelengths without including SMP composite material.

In another approach, a material may be cast into a mold (e.g., an LCE mold) under ambient conditions (e.g., room temperature). After the material is cast, the mold is exposed to a stimulus (e.g., light, heat, solvent, magnetic field, etc.) to change the shape of the mold (e.g., expand, contract, etc.) and self-release the cast product. This type of active self-releasing molding is of interest to reduce manufacturing time and for cast materials that require minimal handling (e.g., optics and manufacturing with low dexterity robotic interactions.

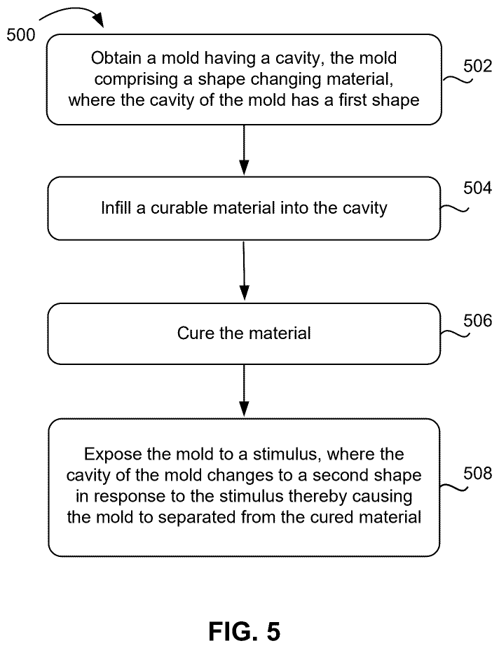

FIG. 5 shows a method 500 for casting a part using a self-releasing mold, in accordance with another aspect an embodiment. As an option, the present method 500 may be implemented to construct structures such as those shown in the other FIGS. described herein. Of course, however, this method 500 and others presented herein may be used to form structures for a wide variety of devices and/or purposes which may or may not be related to the illustrative embodiments listed herein. Further, the methods presented herein may be carried out in any desired environment. Moreover, more, or less operations than those shown in FIG. 5 may be included in method 500, according to various embodiments. It should also be noted that any of the aforementioned features may be used in any of the embodiments described in accordance with the various methods.

Method 500 may begin with operation 502 of obtaining a mold having a cavity, where the mold comprises a shape changing material as described herein. In some approaches, the mold is used to cast a product under ambient conditions in the absence of a stimulus. In the original shape of the mold, the surface of the cavity has predefined features in a negative form such that the cast material reflects a positive form of the mold pattern. As described herein, the mold may be formed using AM techniques such as DIW, lithography-based AM system (e.g., PμSL), etc.

Operation 504 include infilling a curable material in the cavity of the mold. As described herein, the curable material may be a material selected according to the material of the mold in order to prevent association (e.g., adherence) between the curable material and the mold material. For example, a hydrophilic curable material may be cast in a mold comprised of hydrophobic material.

Operation 506 includes curing the material cast in the cavity of the mold. The curing treatment of the castable material is preferably not a similar treatment for stimulating a shape change in the mold. In one approach, during the curing of the castable material, the shape of the mold remains unchanged. The castable material is cured to a predefined extent. For example, the castable material is exposed to a curing treatment until about 100% of the material is cured. The duration of time for curing is determined according to the composition of the curable (e.g., castable) material. During the curing of the casting material, e.g., silicone elastomer, the mold material does not adhere to the casting material.

Operation 508 includes exposing the mold to a stimulus. The cavity of the mold changes shape in response to the stimulus, where the stimulus-induced shape is different than the original shape of the cavity of the mold. The mold is then separated from the cured material in the cavity. The shape of the mold is not the same shape as the cast material that was shaped in the cavity of the mold, and thus, the mold is released from the cast material during exposure of the mold to a stimulus. Removing the stimulus from the mold causes the mold to return to the original shape of the mold.

In preferred approaches, the mold may be re-used after casting a part. The cast material and the mold material are tuned so that the cast material does not adhere to the mold material. The mold may be engineered so that the material of the mold expands or contracts in response to an external stimuli. Mold material that changes shape in response to an external stimuli is preferably reusable after releasing the cast material.

### One Example of a Self-Releasing Mold: A LCE Mesogen Mold

According to one approach, a LCE mesogen ink does not adhere to silicone elastomers and thus, a LCE mesogen mold actuates in response to a change in external stimuli, and releases a cast comprising a silicone elastomer material.

A 3D mold may be fabricated using an LCE mesogen resin and a stereolithography (SLA) AM technique with a UV cure. An LCE structure formed by SLA techniques has a predefined pattern of voxels, where each voxel is comprised of LC molecules substantially aligned in a predefined orientation. A voxel is a local volume element that adds a third dimension (z-dimension) to a two-dimensional (2D) pixel (x-y dimensions). Further, the SLA process includes forming voxels having substantially aligned LCs in an orientation specifically defined for inducing a shape change in the printed part with a higher actuation of strain % (e.g., up to about 50% strain) in response to a stimulus.

Note, for AM techniques of forming LCE molds, the shape change may be measured as strain in multiple directions. The direction of the shape change may be determined according to the AM technique. For example, in DIW printing techniques, an extruded filament, when heated, may contract along its axis and expand perpendicular to its axis. In other approaches, the 3D structure as a whole may change shape in various directions according to a complex alignment map.

The methodology of printing a 3D part with substantially aligned LCEs as a shape changing material are disclosed in U.S. Pat. Nos. 11,794,406 and 11,745,420, which are herein incorporated by reference. The resultant 3D structure formed by AM techniques is characterized as exhibiting a shape change in response to a stimulus. The reversible shape change in the 3D structure may be realized with a formulation having a high actuation strain %, e.g., up to about 50% strain.

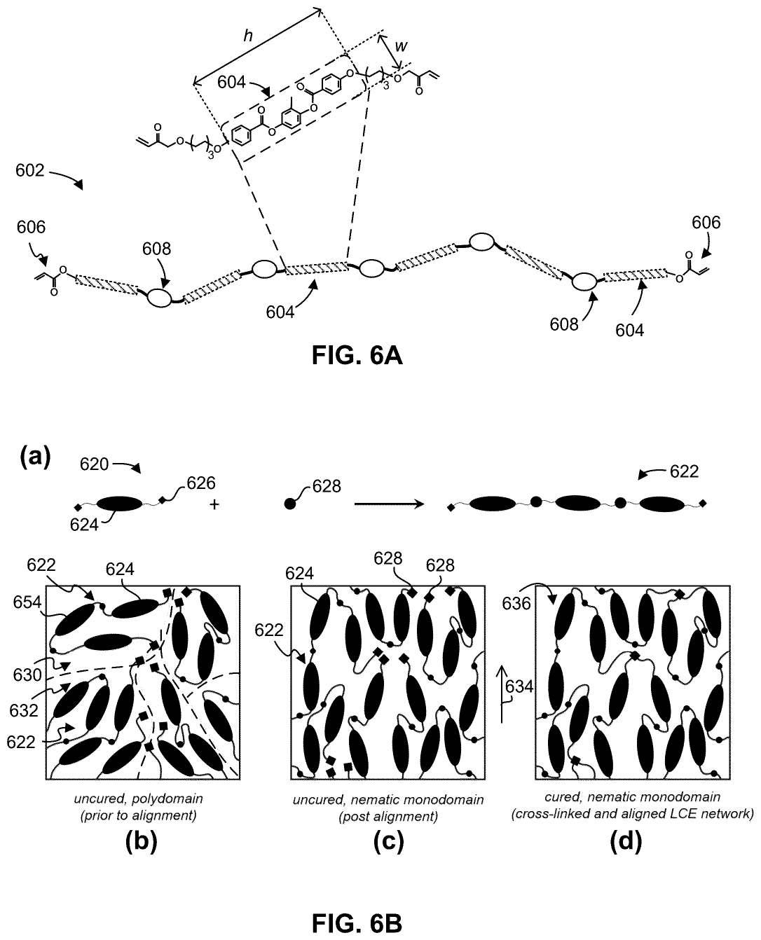

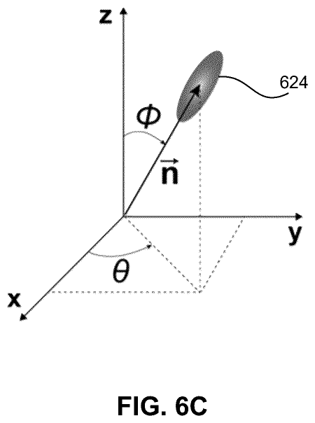

As illustrated in FIG. 6A, part (a), one example of an LC oligomer 602 includes at least one mesogen 604 and at least one amine chain extender molecule 608 positioned between each mesogen 604 of the main chain with reactive end groups 606 on each end of the LC oligomer (e.g., main chain LC oligomer, LC polymer, etc.).

Theoretically, an extent of shape change of a formed 3D structure may be configured according to the aspect ratio of the mesogen molecules of the LC oligomers. The structure of the LC oligomers may be characterized by the aspect ratio and stiffness of the mesogen molecules. For example, the mesogen 604 has an aspect ratio defined by the height h to width w. A mesogen having 4 benzene rings is a stiffer molecule (having an aspect ratio h:w of about 3:1) than a mesogen with 1 or 2 benzene rings (having an aspect ratio of about 1.5:1). Upon stimulation, a mesogen molecule may reorient 90° upwards, and thus, a bigger aspect ratio of the mesogen molecule results in a greater degree of shape change. However, a higher aspect ratio of the mesogen molecules may result in a higher viscosity of the resin, and thus, a more rigid resin may inhibit printing efficiency. In a preferred approach, an aspect ratio (i.e., height to width) of the mesogens is about 3:1 to about 5:1. In some approaches, main chain LC oligomers include rigid LC mesogens with a reactive end group on each end for curing (e.g., crosslinking) the LC oligomers into LCEs. In some approaches, each LC oligomer of the resin may include about 3 to 15 mesogen molecules along the backbone of the LC oligomer.

A formulation of an LCE mesogen ink/resin may be tuned for the type of mold and shape change desired for casting a specific material. Different mesogens may have different nematic-to-isotropic transition temperatures. For example, mesogens having a higher molecular weight, e.g., higher than a small molecule (i.e., a small molecule being <900 daltons), may result in a higher nematic-to-isotropic transition temperature. For mesogens having a nematic-to-transition temperatures of 100° C., the ratio of different mesogens may be used to lower the nematic-to-isotropic transition temperature below 100° C. Alternatively, the nematic-to-isotropic transition temperature of an LC oligomer may be raised by incorporating more rigid mesogen molecules as a part of the oligomer.

In some approaches, the ratio of mesogens to chain extender molecules in the LC oligomer (e.g., LC polymer) that comprise the resin may characterize the extent of shape change of the 3D structure formed using the resin. For example, the ratio of mesogens to chain extenders may determine the extent, type, etc. of shape change of the formed 3D structure. In various approaches, the chain extender molecules between the mesogens may include amines, etc. In one approach, a ratio of mesogen to the chain extender may be about 1:1. In some approaches, a higher ratio is preferred, for example around 1.4:1 up to 2:1 mesogen to chain extender. An LC oligomer having a higher ratio of mesogens to chain extender results in shorter polymer chains, whereas an LC oligomer having a lower ratio of mesogens to chain extenders results in longer polymer chains. Longer LC oligomer chains substantially aligned and cured in a LCE matrix may result in a 3D structure having a capability of a larger shape change in response to external stimuli.

As illustrated in part (a) of FIG. 6B, the synthesis 620 of main chain LC oligomers 622 includes the combination of mesogens 624 having reactive end groups 626 with chain extender molecules 628 to form an LC oligomer 622 having at least one chain extender molecule 628 positioned between the mesogens 624 and a reactive end group 626 positioned at each end of the LC oligomer 622.

Parts (b), (c), and (d) of FIG. 6B illustrate the alignment of a portion of 3D structure having LC oligomers 622 during formation of the 3D part (e.g., mold structure). Part (b) illustrates the initial material prior to alignment. The LC oligomers 622 are present as a polydomain of uncured oligomers, the polydomain comprising a plurality of domains 630, 632 of LC molecules, (e.g., mesogens 624). For illustrative purposes only, the individual domains 630, 632 are defined by a dashed line between the domains. A domain 530 represents a group of LC molecules aligned in a similar orientation. The orientation of the as-deposited alignment of the resin as a layer may include a plurality of sub-domains 630, 632, e.g., a polydomain, having different, randomly aligned LC molecules, and each domain having at least one mesogen 624 oriented along a similar alignment direction. A polydomain is the isotropic state where all LCs are randomly aligned, i.e., the alignment is undefined.

Part (c) of FIG. 6B illustrates the alignment of LC oligomers corresponding to a defined orientation direction. For example, aligned LC molecules, e.g., mesogens 624, may form a nematic monodomain having an orientation in defined alignment direction 634. In one embodiment, as described herein, an orientation of aligned LC molecules may correspond to alignment of molecules of an illuminated portion of the photoalignment material that is contacting the LC molecules. As illustrated here, the mesogens 624 of the LC oligomers 622 are substantially aligned in an orientation direction 634 where a majority of, and preferably at least 90% of, the mesogens 624 are substantially aligned (e.g., within 10° of each other, preferably) in the predefined orientation direction 634 that, in some approaches, may be defined by the polarity of the light illuminating on the formed material during fabrication of the part.

Part (d) of FIG. 6B illustrates cured aligned LC oligomers in the material of a formed 3D structure. Curing the resin of the voxel during alignment of the LC oligomers 622 where the mesogens 624 are substantially aligned in the predefined orientation direction 634 causes the reactive end groups 626 of the LC oligomer 622 to crosslink and form an LCE 636. The LCE mesogens 636 are substantially aligned in the predefined orientation direction 634, and thus result in a cured, nematic monodomain, e.g., a crosslinked and aligned LCE network.

Referring to FIG. 6C, an orientation direction of the liquid crystal molecules, e.g., a mesogen 624 molecule, may be defined by alignment defined in the AM process. A dimensionless unit vector, e.g., liquid crystal director \vec{n} describes the predominant orientation direction of nearby liquid crystals. A liquid crystal director \vec{n} may be decomposed into spherical components as follows:

$$\vec{n} = \{ \begin{matrix}{n}_{x} = cos θ sin ϕ \\ {n}_{y} = sin θ sin ϕ \\ {n}_{z} = cos ϕ\end{matrix}$$

where θ varies between 0° and 360°, and ϕ varies between 0° and 180°. A magnetic field map may be designed to target specific \vec{n} directions. According to various approaches, a product may be formed voxel-by-voxel where each voxel has LC molecules oriented in unique predefined \vec{n} direction. The LC molecules may be aligned in the x-y plane in 360° theta (θ) direction.

In one approach, a mold structure formed with LCE resin may include a complex shape change dynamic may be added to the formed structure. The method of fabricating the mold may include heating the resin to a temperature above the nematic-to-isotropic transition temperature of the mesogen in order to form a portion, voxel, etc. of the layer that cannot undergo a shape change in the formed 3D structure in response to a stimulus. In some approaches, a 3D structure may include some portions that exhibit a shape change in response to a stimulus and some portions that cannot exhibit a shape change in response to a stimulus. In some approaches, the orientation of the aligned LC molecules may be tuned for a specific orientation of bent core mesogens that are biaxial.

As described in the methodology elsewhere cited herein, forming a 3D polymer structure is highly scalable and compatible with additive manufacturing (e.g., 3D printing). In some approaches, AM techniques such as projection micro-stereolithography (PμSL) provides advantages of printing increased part complexity and resolution. Moreover, decreasing the strut diameters of a 3D printed structure while maintaining structural integrity will allow for faster actuation times of shape change of the structure.

In various approaches, physical characteristics of the features of the mold may include filaments arranged in a geometric pattern, a patterned surface defined by stacking filaments, etc. Thus, using these additive manufacturing techniques allows engineering of parts and production of optimal geometry for shape change, mechanical strength, etc.

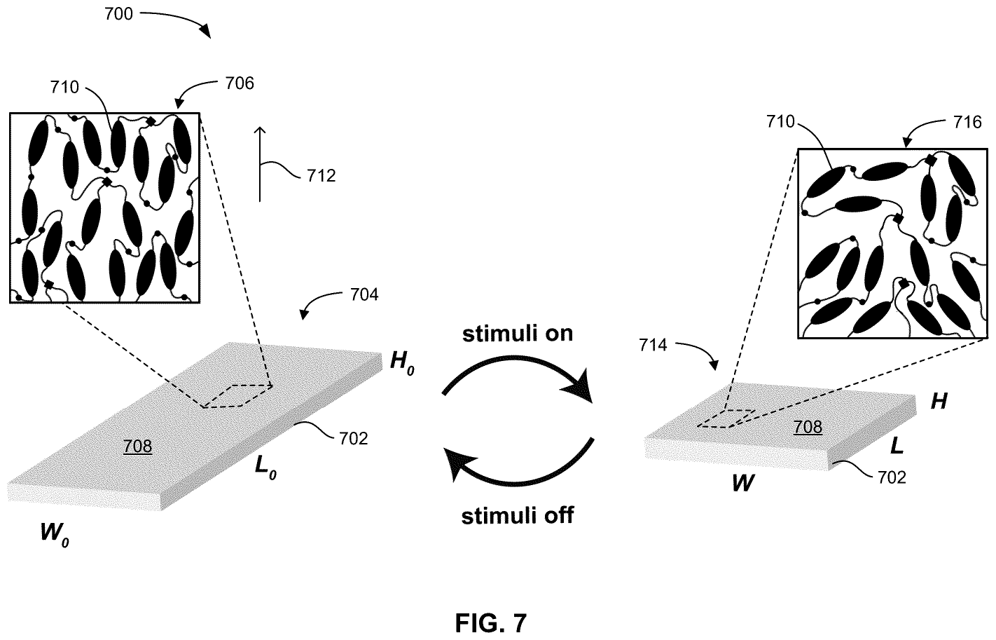

A mold comprised of LCE mesogen material is an example of a mold made of a shape change material. In response to a stimulus, the LCE mesogen material actuates and changes shape. FIG. 7 depicts a schematic drawing of an actuation 700 of an LCE mesogen structure 702, according to one approach. A structure 702 in an as-formed state 704 has a width W₀, length L₀, and height H₀. In the magnified view 706 of the LCE matrix 708, the LC molecules 710 are in a nematic state such that the LC molecules 710 are substantially aligned according to a predefined orientation 712. Upon stimulation of the LCE structure 702, the LCE structure 702 undergoes a shape change such that the stimulated form 714 of the LCE structure 702 now has change in width W and height H, and in particular a significant change in the length L of the structure. The magnified view 716 of the LCE matrix 708 shows the LC molecules 710 are oriented in an unaligned isotropic state. Removing the stimulant, turning off the stimuli, etc. causes the LCE structure 702 to return to the resting, as-formed state 704 in which the LC molecules 710 are substantially aligned along a predefined orientation 712.

### Experimental Results

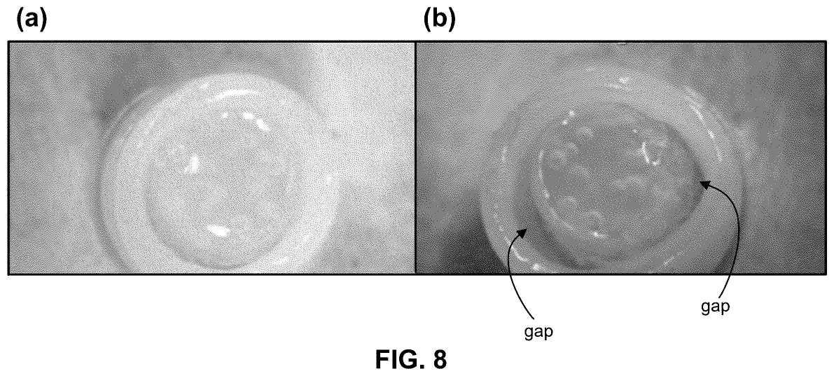

Part (a) of FIG. 8 depicts an image of a cured silicone in an LCE mesogen mold. the LCE mesogen mold was formed using SLA techniques and a UV cure with a resin formulation of RM82 mesogen and n-butyl amine that was mixed with a photoinitiator. The inner structure was formed from a castable material of silica-loaded silicone with applied heat. Part (b) depicts and image of the LCE mesogen mold released from the cured silicone cylinder (inner structure) in the absence of applied heat. The heat was removed, and the structure returned to room temperature. The gaps between the cured silicone cylinder and the mold indicate the mold changed shape to a shape different from the cured silicone cylinder thereby producing gaps between the two structures. The cured silicone cylinder was subsequently released from the mold.

### In Use

Various embodiments described herein include ink and manufacturing advancements that allow the printing of complex 3D molds such that a mold can be programmed to shape a cast material and self-release once the material is cured. This type of molding is of interest to reduce manufacturing time of optics and manufacturing with low dexterity robotic interactions.

The inventive concepts disclosed herein have been presented by way of example to illustrate the myriad features thereof in a plurality of illustrative scenarios, aspects of an inventive concept, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects of an inventive concept have been described above, it should be understood that they have been presented by way of example only, and not limitation. Thus, the breadth and scope of an aspect of an inventive concept of the present invention should not be limited by any of the above-described exemplary aspects of an inventive concept but should be defined only in accordance with the following claims and their equivalents.

What is claimed:

1. A product comprising:
a three-dimensional structure comprising a shape changing material,
wherein the three-dimensional structure has a predefined cavity configured to function as a mold for a castable material,
wherein the three-dimensional structure is characterized as exhibiting a shape change in response to a stimulus, wherein the shape change is reversible,
wherein the three-dimensional structure is configured to release the castable material in response to the stimulus.

2. The product as recited in claim 1, wherein the shape changing material is a liquid crystal elastomer mesogen material.

3. The product as recited in claim 1, wherein the shape changing material is a shape memory polymer material.

4. The product as recited in claim 1, wherein the shape changing material is a hydrogel.

5. The product as recited in claim 1, wherein the shape changing material includes a first additive configured to inhibit adherence of the castable material to a surface of the cavity.

6. The product as recited in claim 1, wherein the shape changing material includes a second additive configured to cause a shape change of the three-dimensional structure in response to the stimulus.

7. The product as recited in claim 6, wherein the second additive is selected from the group consisting of: a magnetic filing, a piezoelectric ceramic material, and a metal.

8. The product as recited in claim 1, wherein a surface of the cavity has a predefined pattern of features.

9. A method for casting a part using a self-releasing mold, the method comprising:
obtaining a mold having a cavity, the mold comprising a shape changing material, wherein the cavity of the mold has a first shape;
exposing the mold to a stimulus, wherein the cavity of the mold changes to a second shape in response to the stimulus;
infilling a curable material into the cavity;
curing the curable material; and
reducing the stimulus, wherein the cavity of the mold changes to the first shape in the reduced stimulus thereby causing the mold to be separated from the cured material.

10. The method as recited in claim 9, wherein the cavity has a surface comprising predefined features.

11. The method as recited in claim 10, wherein the mold is formed using a direct ink writing technique.

12. The method as recited in claim 10, wherein the is formed using a lithography-based additive manufacturing system.

13. The method as recited in claim 9, wherein the mold is comprised of a composition that does not adhere to the cured material.

14. The method as recited in claim 9, wherein the stimulus is selected according to a composition of the shape changing material.

15. The method as recited in claim 9, wherein the stimulus is selected from the group consisting of: a solvent, radiation, heat, pressure, an electric field, and a magnetic field.

16. The method as recited in claim 9, wherein the shape changing material includes a liquid crystal elastomer mesogen material.

17. The method as recited in claim 9, wherein the shape changing material includes a shape memory polymer material.

18. The method as recited in claim 9, wherein the shape changing material includes a hydrogel material.

19. The method as recited in claim 9, wherein the shape changing material includes an additive configured to cause a shape change of the mold in response to the stimulus, wherein the additive is selected from the group consisting of: a magnetic filing, a piezoelectric ceramic material, and a metal.

20. A method of casting a part using a self-releasing mold, the method comprising:
obtaining a mold having a cavity, the mold comprising a shape changing material, wherein the cavity of the mold has a first shape;
infilling a curable material into the cavity;
curing the curable material; and
exposing the mold to a stimulus, wherein the cavity of the mold changes to a second shape in response to the stimulus thereby causing the mold to be separated from the cured material.
